(19) United States
(12) Patent Application Publication
(10) Pub. No.: US 2011/0279551 A1
(43) Pub. Date: Nov. 17, 2011

(54) Inkjet print head and inkjet printer including the same

(75) Inventors: Tae Kyung Lee, Suwon (KR); Jae Chang Lee, Hwaseong (KR); Hwa Sun Lee, Hwaseong (KR); Yoon Sok Park, Suwon (KR); Sung Wook Kim, Suwon (KR)

(73) Assignee: SAMSUNG ELECTRO-MECHANICS CO., LTD., Suwon (KR)

(21) Appl. No.: 12/926,868

(22) Filed: Dec. 14, 2010

(30) Foreign Application Priority Data
May 11, 2010 (KR) 10-2010-0044196

(51) Int. Cl. B41J 2/045

(52) U.S. Cl. 347/68

(57) ABSTRACT

There is provided an inkjet print head that includes: an inkjet head plate with a plurality of head cells including ink passages where introduced ink is ejected through a nozzle by passing through a pressure chamber; and a piezoelectric actuator formed on the top of the inkjet head plate and formed at a position corresponding to the pressure chamber, wherein the area of at least one of the pressure chamber and the piezoelectric actuator is changed to make ejection characteristics of the ink ejected from the plurality of head cells uniform.

### CROSS-REFERENCE TO RELATED APPLICATIONS

This application claims the priority of Korean Patent Application No. 10-2010-0044196 filed on May 11, 2010, in the Korean Intellectual Property Office, the disclosure of which is incorporated herein by reference.

### BACKGROUND OF THE INVENTION

1. Field of the Invention

The present invention relates to an inkjet print head and an inkjet printer including the same, and more particularly, to an inkjet print head in which the ink ejection velocity or volume of all head cells of the inkjet print head is uniform and an inkjet printer including the same.

2. Description of the Related Art

In general, an inkjet print head is a structure which converts an electric signal into physical force in order to eject ink, in the form of a micro-droplet, through a small nozzle. The inkjet print head may be classified in accordance with an ink ejection method and in particular, a piezoelectric inkjet print head which ejects ink by using a piezoelectric substance has been widely used in an industrial inkjet printer in recent years.

For example, a circuit pattern is directly formed on a flexible printed circuit board (FPCB) by ejecting ink made by melting metal such as gold, silver, or the like or industrial graphics or manufacturing a liquid crystal display (LCD) and an organic light emitting diode (OLED), and a solar cell.

The inkjet print head may be configured by changing the number of nozzles depending on its usage and for example, contains 96 nozzles, 256 nozzles, or the like. An ink passage is formed for each nozzle and ink supplied to each ink passage is ejected from each nozzle in the form of a micro-droplet. At this time, the ink ejection characteristics of the nozzles are in that droplet ejection velocity or volume is not actually uniform in all the nozzles.

The influence of crosstalk generated by rapidly changing pressure in the ink passage while ink is ejected through a plurality of nozzles, the influence of a processing error or an arrangement error, or vibrations within an adjacent head cell while the ink passage of the inkjet print head is formed, and the like may all be causes of the nonuniform ejection characteristics of the ink droplets.

In the case in which the droplet ejection velocity or volume is not uniform in all the nozzles, a joint stain between swaths is generated in printing and when the droplet ejection velocity decreases, the ink ejection characteristics in which a momentum of the droplet becomes weak to cause wetting are deteriorated.

### SUMMARY OF THE INVENTION

An aspect of the present invention provides an inkjet print head in which the droplet ejection velocity or volume of all nozzles of the inkjet print head is uniform and an inkjet printer including the same.

According to an aspect of the present invention, there is provided an inkjet print head that includes: an inkjet head plate with a plurality of head cells including ink passages where introduced ink is ejected through a nozzle by passing through a pressure chamber; and a piezoelectric actuator formed on the top of the inkjet head plate and formed at a position corresponding to the pressure chamber, wherein the area of at least one of the pressure chamber and the piezoelectric actuator is changed to make ejection characteristics of the ink ejected from the plurality of head cells uniform.

The plurality of head cells may include head cells of a nonuniform region formed at an edge region of the inkjet head plate and head cells of a uniform region formed at the inside of the edge region, and the area of at least one of the pressure chamber and the piezoelectric actuator of the head cells of the nonuniform region may be altered more greatly than that of the head cell of the uniform region.

The plurality of head cells may include head cells of the nonuniform region formed at the edge region of the inkjet head plate and head cells of the uniform region formed at the inside of the edge region, and the area of at least one of the pressure chamber and the piezoelectric actuator of the head cells of the nonuniform region may be altered more greatly stepwise from the center to the edge of the inkjet head plate.

The ink ejection characteristic may be a velocity deviation Δνᵢ, the plurality of head cells may include head cells of the uniform region of which the velocity deviation is in the range of 0 to 5% and head cells of the nonuniform region of which the velocity deviation is larger than 5%, and the area of at least one of the pressure chamber and the piezoelectric actuator of the head cells of the nonuniform region may be changed in proportion to the velocity deviation. Herein, Δν=|νₐᵥₑ−νᵢ|/νₐᵥₑ×100 (νᵢ represents the ejection velocity of an i-th head cell and νₐᵥₑ represents the average ejection velocity of head cells of the entire region).

The ink ejection characteristic may be a volume deviation ΔVᵢ, the plurality of head cells may include head cells of the uniform region of which the volume deviation is in the range of 0 to 5% and head cells of the nonuniform region of which the volume deviation is larger than 5%, and the area of at least one of the pressure chamber and the piezoelectric actuator of the head cells of the nonuniform region may be changed in proportion to the volume deviation. Herein, ΔVᵢ=|Vₐᵥₑ−Vᵢ|/Vₐᵥₑ×100 (Vᵢ represents the volume of ejected ink of an i-th head cell and Vₐᵥₑ represents the average volume of ejected ink of head cells of the entire region).

The area of at least one of the pressure chamber and the piezoelectric actuator of the head cells of the nonuniform region may be changed to 20% or less smaller than the area of at least one of the pressure chamber and the piezoelectric actuator of the head cell of the uniform region.

According to another aspect of the present invention, there is provided an inkjet print head that includes: an upper substrate including an ink inlet; a lower substrate with a passage where ink introduced into the ink inlet is ejected through a plurality of nozzles by passing through a plurality of pressure chambers; and a plurality of piezoelectric actuators formed on the top of the lower substrate and formed at positions corresponding to the plurality of pressure chambers, wherein the area of at least one of the pressure chamber and the piezoelectric actuator is changed to make ejection characteristics of the ink ejected from the plurality of nozzles uniform.

The inkjet print head may include a nonuniform region positioned at an edge region of the inkjet print head and a uniform region disposed at the inside of the edge region, and the area of at least one of the pressure chamber and the piezoelectric actuator of the nonuniform region may be altered more greatly than that of the uniform region.

The inkjet print head may include the nonuniform region positioned at the edge region of the inkjet print head and the uniform region disposed at the inside of the edge region, and the area of at least one of the pressure chamber and the piezoelectric actuator of the nonuniform region may be changed largely stepwise from the center of to the edge of the inkjet print head.

The ink ejection characteristic may be a velocity deviation Δνᵢ, the inkjet print head includes the uniform region of which the velocity deviation is in the range of 0 to 5% and the nonuniform region of which the velocity deviation may be larger than 5%, and the area of at least one of the pressure chamber and the piezoelectric actuator of the nonuniform region may be changed in proportion to the velocity deviation. Herein, Δνᵢ=|νₐᵥₑ−νᵢ|/νₐᵥₑ×100 (νᵢ represents the ejection velocity of an i-th nozzle and νₐᵥₑ represents the average ejection velocity of nozzles of the entire region).

The ejection characteristic may be a volume deviation ΔVᵢ, the inkjet print head may include the uniform region of which the volume deviation is in the range of 0 to 5% and the nonuniform region of which the volume deviation is larger than 5%, and the area of at least one of the pressure chamber and the piezoelectric actuator of the nonuniform region may be changed in proportion to the volume deviation. Herein, ΔV=|Vₐᵥₑ−Vᵢ|/Vₐᵥₑ×100 (Vᵢ represents the volume of ink ejected from the i-th nozzle and Vₐᵥₑ represents the average volume of ink ejected from nozzles of the entire region).

The area of at least one of the pressure chamber and the piezoelectric actuator of the nonuniform region may be changed to 20% or less smaller than the area of at least one of the pressure chamber and the piezoelectric actuator of the uniform region.

According to yet another aspect of the present invention, there is provided an inkjet printer that includes: an inkjet head ejecting ink onto one surface of a fed printing medium; a support supporting the printing medium below the inkjet head; and a carrier guiding the movement of the inkjet head on the printing medium, wherein the inkjet head includes an inkjet head plate with a plurality of head cells including ink passages where introduced ink is ejected through a nozzle by passing through a pressure chamber; and a piezoelectric actuator formed on the top of the inkjet head plate and formed at a position corresponding to the pressure chamber, wherein the area of at least one of the pressure chamber and the piezoelectric actuator is changed to make ejection characteristics of the ink ejected from the plurality of head cells uniform.

The plurality of head cells may include head cells of a nonuniform region formed at an edge region of the inkjet head plate and head cells of a uniform region formed at the inside of the edge region, and the area of at least one of the pressure chamber and the piezoelectric actuator of the head cells of the nonuniform region may be changed more largely than that of the head cell of the uniform region.

The plurality of head cells may include head cells of the nonuniform region formed at the edge region of the inkjet head plate and head cells of the uniform region formed at the inside of the edge region, and the area of at least one of the pressure chamber and the piezoelectric actuator of the head cells of the nonuniform region may be altered more greatly stepwise from the center to the edge of the inkjet head plate.

The ink ejection characteristic may be a velocity deviation Δνᵢ, the plurality of head cells may include head cells of the uniform region of which the velocity deviation is in the range of 0 to 5% and head cells of the nonuniform region of which the velocity deviation is larger than 5%, and the area of at least one of the pressure chamber and the piezoelectric actuator of the head cells of the nonuniform region may be changed in proportion to the velocity deviation. Herein, Δνᵢ=|νₐᵥₑ−νᵢ|/νₐᵥₑ×100 (νᵢ represents the ejection velocity of an i-th head cell and νₐᵥₑ represents the average ejection velocity of head cells of the entire region).

The ink ejection characteristic may be a volume deviation ΔV₁, the plurality of head cells may include head cells of the uniform region of which the volume deviation is in the range of 0 to 5% and head cells of the nonuniform region of which the volume deviation may be larger than 5%, and the area of at least one of the pressure chamber and the piezoelectric actuator of the head cells of the nonuniform region may be changed in proportion to the volume deviation. Herein, ΔVᵢ=|Vₐᵥₑ−Vᵢ|/Vₐᵥₑ×100 (Vᵢ represents the volume of ejected ink of an i-th head cell and Vₐᵥₑ represents the average volume of ejected ink of head cells of the entire region).

The area of at least one of the pressure chamber and the piezoelectric actuator of the head cell of the nonuniform region may be changed to 20% or less smaller than the area of at least one of the pressure chamber and the piezoelectric actuator of the head cell of the uniform region.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view of an inkjet print head according to a first exemplary embodiment of the present invention;

FIG. 2 is a plan view of an inkjet print head according to a first exemplary embodiment of the present invention;

FIG. 3 is a graph illustrating the droplet ejection velocity of an inkjet print head according to a first exemplary embodiment of the present invention;

FIG. 4 is a graph illustrating the droplet ejection velocity of an inkjet print head according to a comparative example;

FIG. 5 is an exploded perspective view of an inkjet print head according to a second exemplary embodiment of the present invention;

FIG. 6 is a plan view of a lower substrate of an inkjet print head according to a second exemplary embodiment of the present invention;

FIG. 7 is an exploded perspective view of an inkjet print head according to a third exemplary embodiment of the present invention;

FIG. 8 is a plan view of a lower substrate of an inkjet print head according to a third exemplary embodiment of the present invention;

FIGS. 9A TO 9D is a graph illustrating the change of droplet ejection volume by an inkjet print head according to a fourth exemplary embodiment of the present invention; and

FIG. 10 is a diagram illustrating the configuration of an inkjet printer including an inkjet print head according to the present invention.

### DETAILED DESCRIPTION OF THE PREFERRED EMBODIMENT

Exemplary embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, and those are to be construed as being included in the spirit of the present invention.

Further, throughout the drawings, the same or similar reference numerals will be used to designate the same components or like components having the same functions in the scope of the similar idea.

In general, in an inkjet print head, an ink ejection characteristic is measured for each nozzle, and for example, the droplet ejection characteristic of each nozzle is measured, and when a value acquired by dividing a difference between the maximum velocity and the minimum velocity by average velocity and representing it as %, i.e., {(νₘₐₓ−υₘᵢₙ)/νₐᵥₑ}×100 deviates from a predetermined range, i.e., 0 to 10%, it may be determined that the ink ejection characteristics are not uniform. In the inkjet print head of which the ink ejection characteristics are not uniform, the ink ejection characteristics can be uniform by configuring an inkjet print head as in the exemplary embodiment of the present invention to be described below. Meanwhile, a determination criterion to determine whether or not the ink ejection characteristics are uniform is exemplary and in particular, such a range may be changed depending on the conditions and design specifications which are required.

Further, in the exemplary embodiment of the present invention to be described below, a plurality of head cells constituting the inkjet print head will be described by dividing a uniform region in which the droplet ejection velocity is uniform and a nonuniform region in which the droplet ejection velocity is not uniform.

For example, in the plurality of head cells constituting the inkjet print head, a region in which droplet ejection velocity deviation Δνᵢ of each head cell is in the range of 0 to 5% may be determined as the uniform region and the rest head cells may be determined as the nonuniform region. The velocity deviation Δνᵢ may be deduced by the following equation.

Δυᵢ=|υₐᵥₑ−υᵢ|/υₐᵥₑ×100 Equation 1

Herein, νᵢ represents the ejection velocity of an i-th head cell and represents the average ejection velocity υₐᵥₑ of head cells in the entire region.

Meanwhile, a criterion to divide the entire region into the uniform region and the nonuniform region of the ink ejection characteristics is exemplary and in particular, the droplet ejection velocity deviation range to determine the uniform region may be changed depending on the required conditions and design specifications.

Further, in the plurality of head cells constituting the inkjet print head according to the present invention, a region in which the droplet ejection volume deviation ΔVᵢ of each head cell is in the range of 0 to 5% may be determined as the uniform region and the rest head cells may be determined as the nonuniform region. The volume deviation ΔVᵢ may be deduced by the following equation.

ΔVᵢ=|Vₐᵥₑ−Vᵢ|/Vₐᵥₑ×100 Equation 2

Herein, Vᵢ represents the droplet ejection volume of the i-th head cell and Vₐᵥₑ represents the average droplet ejection volume of the head cells of the entire region.

Meanwhile, the criterion to divide the entire region into the uniform region and the nonuniform region of the ink ejection characteristics is exemplary and in particular, the droplet ejection volume deviation range to determine the uniform region may be changed depending on the required conditions and design specifications.

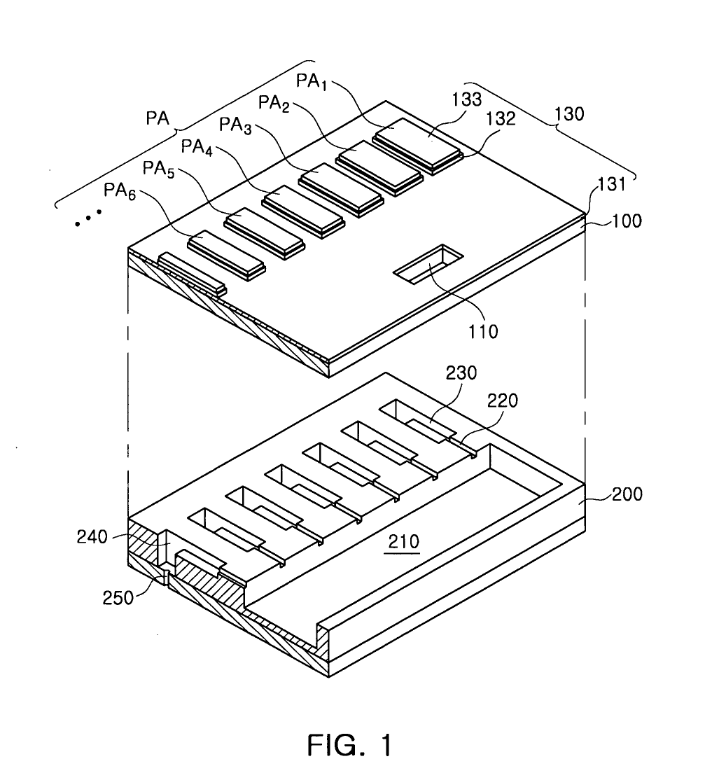

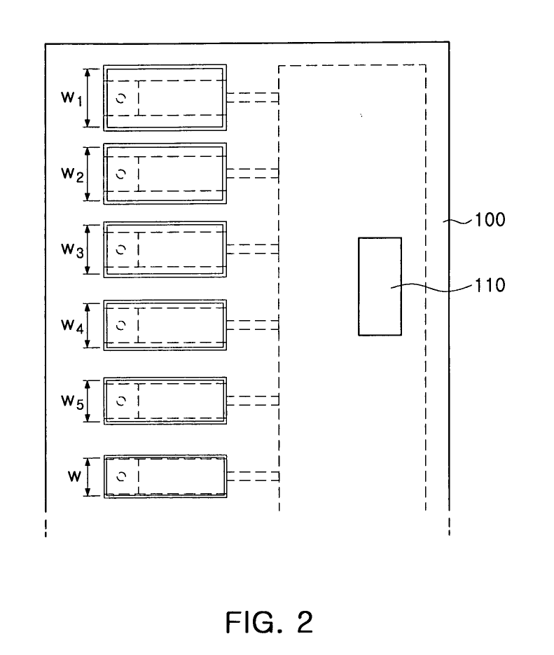

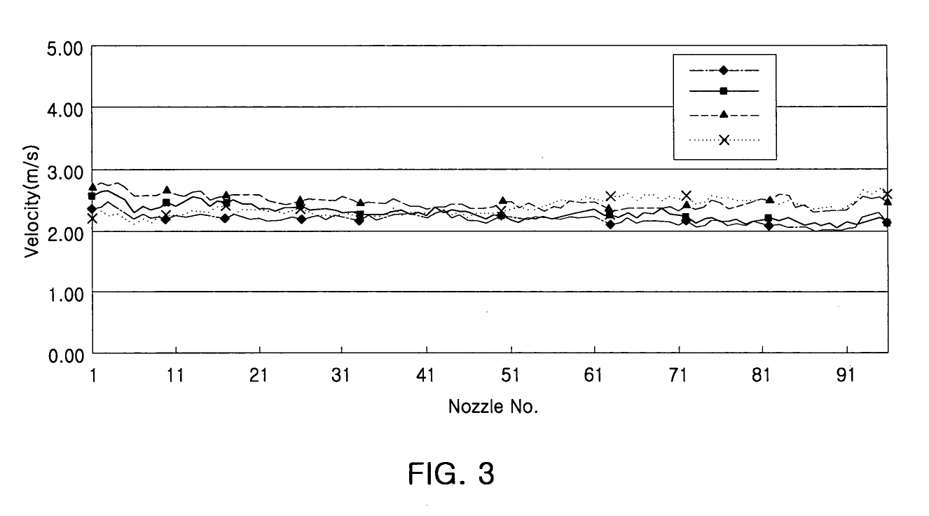

FIG. 1 is an exploded perspective view of an inkjet print head according to a first exemplary embodiment of the present invention, FIG. 2 is a plan view of an inkjet print head according to a first exemplary embodiment of the present invention, and FIG. 3 is a graph illustrating the droplet ejection velocity of an inkjet print head according to a first exemplary embodiment of the present invention. Referring to FIGS. 1 and 2, the inkjet print head according to the first exemplary embodiment of the present invention includes an upper substrate 100 and a lower substrate 200 in which ink passages are formed, and a piezoelectric actuator 130 formed on the top of the upper substrate 100.

In the exemplary embodiment, five head cells which are positioned at each of both sides of a length direction of the inkjet print head are determined as the head cells of the nonuniform region. However, in FIGS. 1 and 2, five head cells positioned at the left side of the length direction of the inkjet print head, i.e., 1^{st} to 5^{th} head cells are shown as the head cells of the nonuniform region. Therefore, of course, five head cells positioned at the right side of the length direction of the inkjet print head, i.e., 92^{nd} to 96^{th} head cells (252^{nd} to 256^{th} head cells in the case of 256 nozzles) are the head cells of the nonuniform region.

However, the number of the head cells of the nonuniform region is not limited thereto and may include head cells other than the head cells of the uniform region determined by Equations 1 and 2 and besides, it may include two or more head cells. Herein, the length direction of the inkjet print head represents a direction facing another head cells in a predetermined head cell of the inkjet print head.

The inkjet print head may include an ink inlet 110 into which ink is introduced, formed on the upper substrate 100, a plurality of pressure chambers 230 formed on the lower substrate 200, a manifold 210 transporting the ink introduced into the ink inlet 110 to each of the plurality of pressure chambers 230, and a plurality of nozzles 250 ejecting ink. A plurality of restrictors 220 may be formed between the manifold 210 and the pressure chamber 230 in order to prevent the ink of the pressure chamber from flowing backward to the manifold when the ink is ejected.

At this time, the upper substrate 100 may be a single-crystal silicon substrate or an SOI substrate on which an insulating layer is formed between two silicon layers and the lower substrate 200 may also be formed by the single-crystal silicon substrate or the SOI substrate. Further, the present invention is not limited thereto and the ink passage may be constituted by more substrates and in some cases, the ink passage may be implemented by one substrate. Components constituting the ink passage also are just exemplary and ink passages including various components may be provided depending on the required conditions and design specifications.

The piezoelectric actuator 130 is formed on the top of the upper substrate 100 to correspond to the pressure chamber 230 and provides the driving force for ejecting the ink introduced into the pressure chamber 230 to the nozzle 250. For example, the piezoelectric actuator 130 may include a lower electrode 131 serving as a common electrode, a piezoelectric film 132 transformed by applying voltage thereto, and an upper electrode 133 serving as a driving electrode.

The lower electrode 131 may be formed on the entire surface of the upper substrate 100 and may be made of a conductive metallic material, but is preferably constituted by two thin metallic layers that are made of titanium (Ti) and platinum (Pt). The lower electrode 131 serves as a diffusion preventing layer preventing interdiffusion between the piezoelectric film 132 and the upper substrate 100 in addition to the common electrode. The piezoelectric film 132 is formed on the lower electrode 131 and is disposed to be positioned on the top of each of the plurality of pressure chambers 230. The piezoelectric film 132 may be made of a piezoelectric material, preferably, a lead zirconate titanate (PZT) ceramic material. The upper electrode 133 is formed on the piezoelectric film and may be made of any one material of materials including Pt, Au, Ag, Ni, Ti, and Cu.

In the piezoelectric actuator 130, the widths w₁ to w₅ of the upper electrodes of piezoelectric actuators PA₁ to PA₅ of the head cells of the nonuniform region may be larger outwardly. That is, the upper widths of the upper electrodes may be larger from w₅ to w₁ as the piezoelectric actuators goes from PA₅ to PA₁. At this time, the widths of the piezoelectric films of the piezoelectric actuators PA₁ to PA₅ may also be gradually larger to correspond to the upper electrodes. Herein, the width of the upper electrode or the piezoelectric film of the piezoelectric actuator represents a size in a direction parallel to the length direction of the inkjet print head.

In the exemplary embodiment, in order to make the ink ejection characteristics such as the ejection velocity or ejection volume of the plurality of head cells uniform, the width of the upper electrode of the piezoelectric actuator of the head cell of the nonuniform region is adjust, but it is merely exemplary and the width of the upper electrode and the length of the upper electrode may be adjusted and the area of a horizontal cross-section of the piezoelectric actuator is adjusted or the volume of the piezoelectric actuator is adjusted. As such, the piezoelectric actuator may be variously designed.

Table 1 shown below shows differences in average velocity resulting from an increase amount of the width of the upper electrode of the piezoelectric actuator of the inkjet print head according to the exemplary embodiment.

TABLE 1

| | Average | Increase | |
|---|---|---|---|
| | velocity | amount of width of | Width of |
| | difference | upper electrode | upper |
| No. | (%) | (%) | electrode (μm) |
| 1 | 20.42 | 10 | 319 |
| 2 | 20.19 | 8 | 313.2 |
| 3 | 14.08 | 6 | 307.4 |
| 4 | 9.06 | 4 | 301.6 |
| 5 | 5.96 | 2 | 295.8 |
| 6-91 | 0 | 0 | 290 |
| 92 | 5.96 | 2 | 295.8 |
| 93 | 9.06 | 4 | 301.6 |
| 94 | 14.08 | 6 | 307.4 |
| 95 | 20.19 | 8 | 313.2 |
| 96 | 20.42 | 10 | 319 |

Table 1 represents a case in which an inkjet print head with 96 nozzles, that is, the number of head cells is 96 and in Table 1, the velocity of each cell is calculated on the basis of a transformation amount of the actuator is calculated by using a laser droppler velocity meter (LDV) by applying voltage to the piezoelectric actuator while ink is not filled in the inkjet print head.

The cell number in Table 1 is given sequentially from the left side of the length direction of the inkjet print head and the average velocity difference represents a difference between the velocity of the 6^{th} to 91^{st} head cells of the uniform region and the velocity of the 1^{st} to 5^{th} and the 92^{nd} to 96^{th} head cells of the nonuniform region as a percentage (%) to the velocity of the head cells of the uniform region and the increase amount of the width of the upper electrode represents a difference between the widths of the upper electrodes of the 6^{th} to 91^{st} head cells and the widths of the upper electrodes of the head cells of the nonuniform region as the percentage (%) to the widths of the upper electrodes the head cells of the uniform region.

As shown in Table 1, in the inkjet print head according to the exemplary embodiment, the width of the upper electrode of the piezoelectric actuator is increased by 2% as that is, the head cells go outwardly from the 6^{th} to 91^{st} head cells which are the head cells of the uniform region, that is, from the 5^{th} to 1^{st} head cells and from the 92^{nd} to 96^{th} head cells. That is, the width W₅ of the upper electrode PA₅ of the 5^{th} head cell is increased by 2% and the width W₄ of the upper electrode PA₄ of the 4^{th} head cell is increased by 4% in comparison with the widths w of the upper electrodes of the 6^{th} to 91^{st} head cells which are the head cells of the uniform region. Accordingly, the 1^{st} and 96^{th} head cells which are the outermost head cells are increased by 10% in comparison with the widths of the upper electrodes of the 6^{th} to 91^{st} head cells.

In the exemplary embodiment, the widths of the upper electrodes of the head cells of the nonuniform region are increased by 2% outwardly from the head cells of the uniform region, but it is exemplary and the increase amount of the width of the upper electrode may be, of course, variously determined depending on the required conditions and design specifications.

For example, the widths of the upper electrodes of the head cells of the nonuniform region may be increased by 1% and may be increased by 4%. Further, the widths may be larger in proportion to the velocity deviation or volume deviation acquired in Equations 1 and 2. For example, if the velocity deviation of the 6^{th} head cell among the head cells of the nonuniform region is 6%, the width of the upper electrode of the 6^{th} head cell may be larger than the width of the upper electrode of the head cell of the uniform region by 6%. However, at this time, it is preferable that the increase amount of the width of the upper electrode of the head cell of the nonuniform region is not more than 20%. This is because the size of the inkjet print head is limited.

As shown in Table 1, in regard to the average velocity difference of the head cell of the nonuniform region of the inkjet print head configured above, the average velocity difference is increased outwardly from the head cell of the uniform region. This is because the variation of the piezoelectric actuator of each head cell is also increased as the width of the upper electrode of the piezoelectric actuator is increased.

The graph of FIG. 3 illustrates the measurement of the droplet ejection velocity of 96 head cells by filling ink in the inkjet print head configured above. Referring to FIG. 3, the droplet ejection velocity of the head cells of the nonuniform region, i.e., 1^{st} to 5^{th} and 92^{nd} to 96^{th} shows a substantially similar profile as the velocity of the head cells of the uniform region, i.e., 6^{th} to 91^{st} head cells.

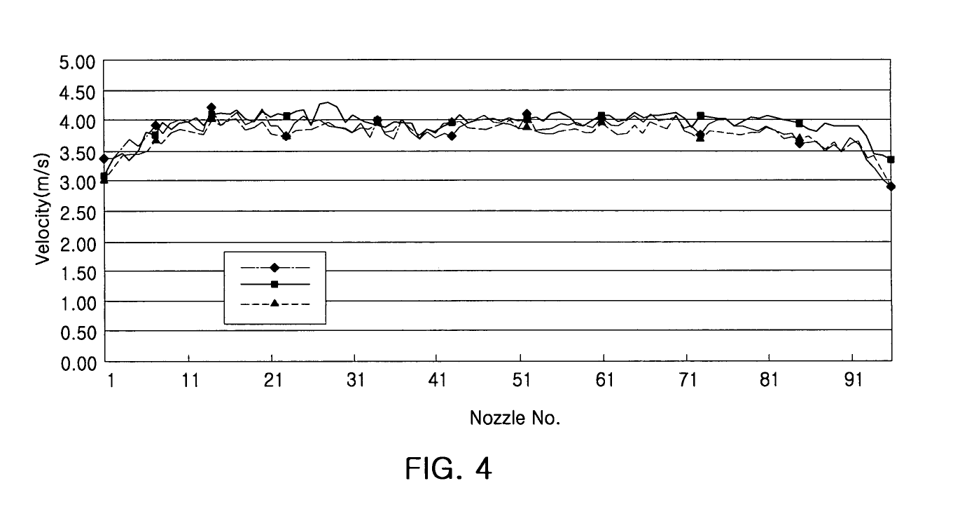

FIG. 4 is a graph illustrating droplet ejection velocity in an ink filling state of an inkjet print head according to a comparative example. In the inkjet print head according to the comparative example, the width of the upper electrodes of all the head cells of the piezoelectric actuator are the same as each other. Therefore, as shown in FIG. 4, the droplet ejection velocity is rapidly decreased in the head cells positioned at both sides of the length direction of the inkjet print head.

Contrary to this, as shown in FIG. 3, in the inkjet print head according to the exemplary embodiment, the droplet ejection velocity in the head cells positioned at both sides of the length direction of the inkjet print head is substantially the same as the droplet ejection velocity of the head cell of the uniform region. Accordingly, ejection performance is uniform in the entire head cells region of the inkjet print head.

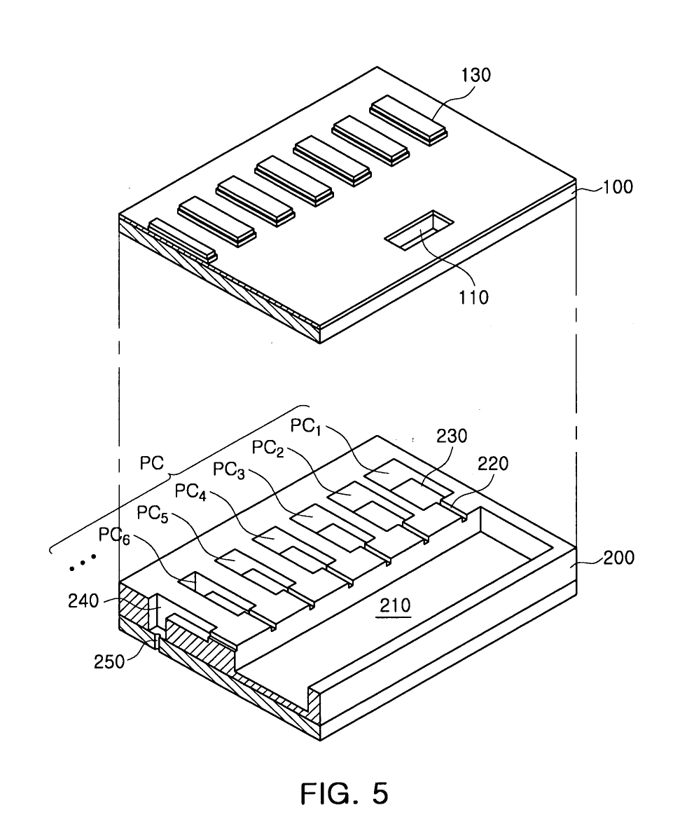

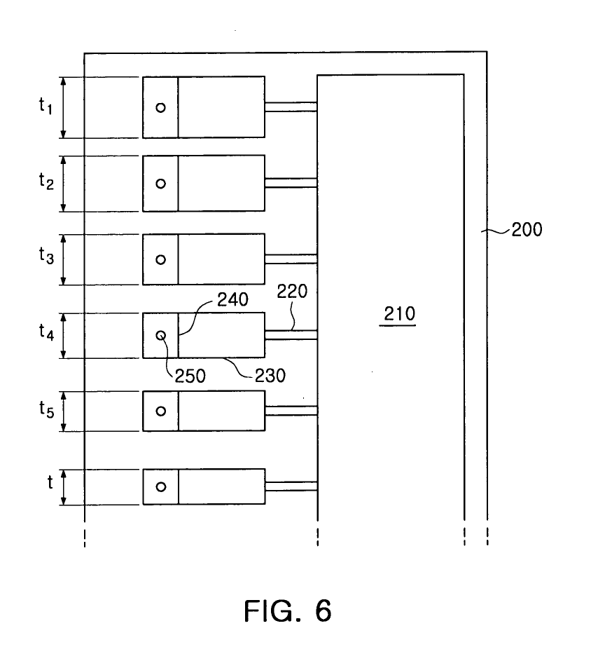

FIG. 5 is an exploded perspective view of an inkjet print head according to a second exemplary embodiment of the present invention and FIG. 6 is a plan view of a lower substrate of an inkjet print head according to a second exemplary embodiment of the present invention.

In the inkjet print head shown in FIGS. 5 and 6, the configuration of the inkjet print head according to the second exemplary embodiment is different from that of the inkjet print head according to the first exemplary embodiment of the present invention in that the head cell of the nonuniform region is larger than the head cell of the uniform region in the width of the upper electrode of the piezoelectric actuator, but the width of the pressure chamber of the head cell of the nonuniform region is larger than the width of the head cell of the uniform region. Therefore, hereinafter, for convenience of description, these different configurations will be described in detail.

As shown in FIGS. 5 and 6, in the inkjet print head according to the second exemplary embodiment of the present invention, the width of the pressure chamber 230 of the head cell of the nonuniform region is larger than that of the head cell of the uniform region. Herein, the width of the pressure chamber represents a size in a direction parallel to the length direction of the inkjet print head.

In the exemplary embodiment, five head cells which are positioned at each of both sides of a length direction of the inkjet print head are determined as head cells of the nonuniform region. However, in FIGS. 5 and 6, five head cells positioned at the left side of the length direction of the inkjet print head, i.e., 1^{st} to 5^{th} head cells are shown as the head cells of the nonuniform region for convenience of description. Therefore, of course, five head cells positioned at the right side of the length direction of the inkjet print head symmetric thereto, i.e., the 92^{nd} to 96^{th} head cells (the 252^{nd} to 256^{th} head cells in the case of 256 nozzles) are also the head cells of the nonuniform region.

However, the number of the head cells of the nonuniform region is not limited thereto and a predetermined range of the droplet ejection velocity deviation determined by Equation 1 or the droplet ejection volume deviation determined by Equation 2 is determined as the head cell of the uniform region, such that the rest head cells may be included in the head cell of the nonuniform region and besides, may include two or more head cells.

The increase amount of the width of the pressure chamber of the head cell of the nonuniform region in the exemplary embodiment may also be larger than the width t of the pressure chamber of the head cell of the uniform region by 2% outwardly and from the pressure chamber PC₅ to the pressure chamber PC₁ as shown in the first exemplary embodiment of the present invention and in a range in which the increase amount of the width of the pressure chamber PC₁ of the outermost head cell is not larger than 20%, the increase amount of the width may be increased in proportion to the velocity deviation or volume deviation of Equation 1 or 2.

As shown in the exemplary embodiment, when the widths t₁ to t₅ of the pressure chambers PC₁ to PC₅ of the head cells of the nonuniform region increase, the volume of the pressure chamber increases and the volume of ink which is filled in the pressure chamber increases. Therefore, although the same driving force of the head cell of the uniform region is provided, larger force acts on ejected droplets, as a result, the ejection volume of the head cell of the nonuniform region is the same as the ejection volume of the head cell of the uniform region.

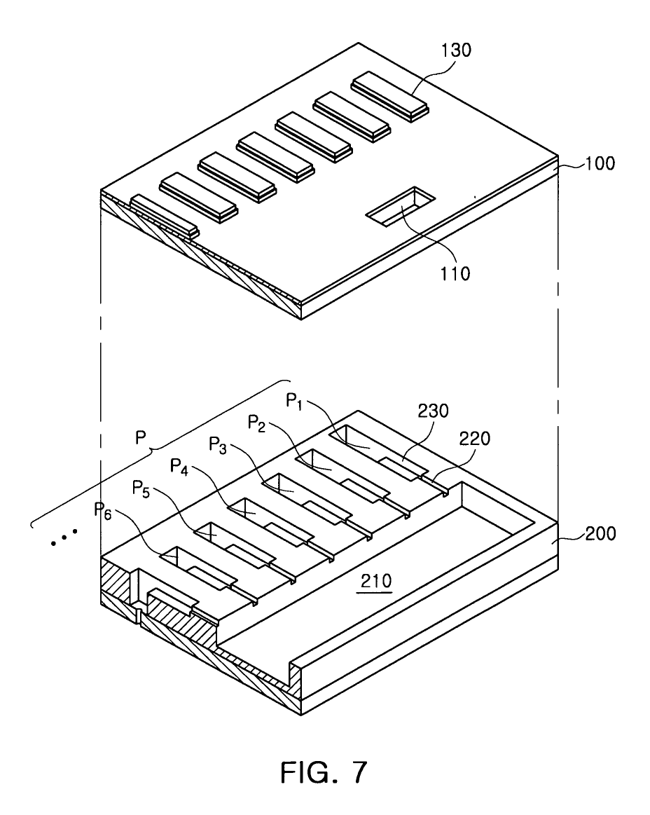

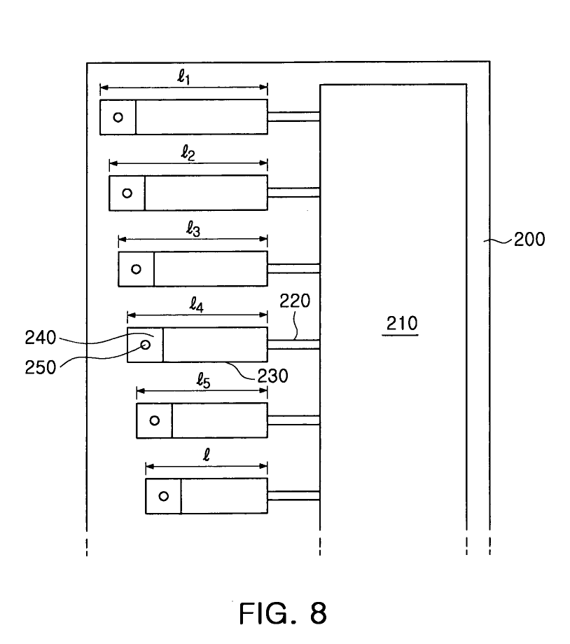

FIG. 7 is an exploded perspective view of an inkjet print head according to a third exemplary embodiment of the present invention and FIG. 8 is a plan view of a lower substrate of an inkjet print head according to a third exemplary embodiment of the present invention.

In the inkjet print head shown in FIGS. 7 and 8, the configuration of the inkjet print head according to the second exemplary embodiment is different from the inkjet print head according to the second exemplary embodiment of the present invention in that the head cell of the nonuniform region is the same as the head cell of the uniform region in the width of the upper electrode of the piezoelectric actuator, but the length of the pressure chamber of the head cell of the nonuniform region is greater than that of the head cell of the uniform region. Therefore, hereinafter, for convenience of description, these different configurations will be described in detail.

As shown in FIGS. 7 and 8, in the inkjet print head according to the third exemplary embodiment of the present invention, the length of the pressure chamber 230 of the head cell of the nonuniform region is larger than that of the head cell of the uniform region. Herein, the length of the pressure chamber represents a size in a direction vertical to the width of the pressure chamber.

In the exemplary embodiment, five head cells which are positioned at each of both sides of a length direction of the inkjet print head are determined as head cells of the nonuniform region. However, in FIGS. 7 and 8, five head cells positioned at the left side of the length direction of the inkjet print head, i.e., the 1^{St} to 5^{th} head cells are shown as the head cells of the nonuniform region for convenience of description. Therefore, of course, five head cells positioned at the right side of the length direction of the inkjet print head symmetric thereto, i.e., the 92^{nd} to 96^{th} head cells (the 252^{nd} to 256^{th} head cells in the case of 256 nozzles) are also the head cells of the nonuniform region.

However, the number of the head cells of the nonuniform region is not limited thereto and a predetermined range of the droplet ejection velocity deviation determined by Equation 1 or the droplet ejection volume deviation determined by Equation 2, i.e., 0 to 5% is determined as the head cell of the uniform region, such that the rest head cells may be included in the head cell of the nonuniform region and besides, may include two or more head cells.

The increase amount of the length of the pressure chamber of the head cell of the nonuniform region in the exemplary embodiment may also be larger than the length 1 of the pressure chamber of the head cell of the uniform region by 2% outwardly in the nonuniform region and from the pressure chamber PC₅ to the pressure chamber PC₁ and in a range in which the increase amount of the length l₁ of the pressure chamber of the outermost head cell is not larger than 20%, a predetermined increase amount may be determined in accordance with the design specifications. Meanwhile, the length may be increased in proportion to the velocity deviation or volume deviation of Equation 1 or 2.

As shown in the exemplary embodiment, when the lengths l₁ to l₅ of pressure chambers P₁ to P₅ increase, the volume of the pressure chamber increases and the volume of ink which is filled in the pressure chamber increases. Therefore, although the same driving force of the head cell of the uniform region is provided, larger force acts on ejected droplets, as a result, the ejection volume of the head cell of the uniform region is the same as the ejection volume of the head cell of the uniform region.

As described above, although the width or length of the pressure chamber has been adjusted in order to make uniform the ink ejection characteristics such as the ejection velocity or ejection volume of the plurality of head cells in the second exemplar embodiment and the third exemplary embodiment, it is exemplary, and the area of the horizontal cross section including both the width and the length of the pressure chamber may be adjusted or the volume of the pressure chamber may be adjusted.

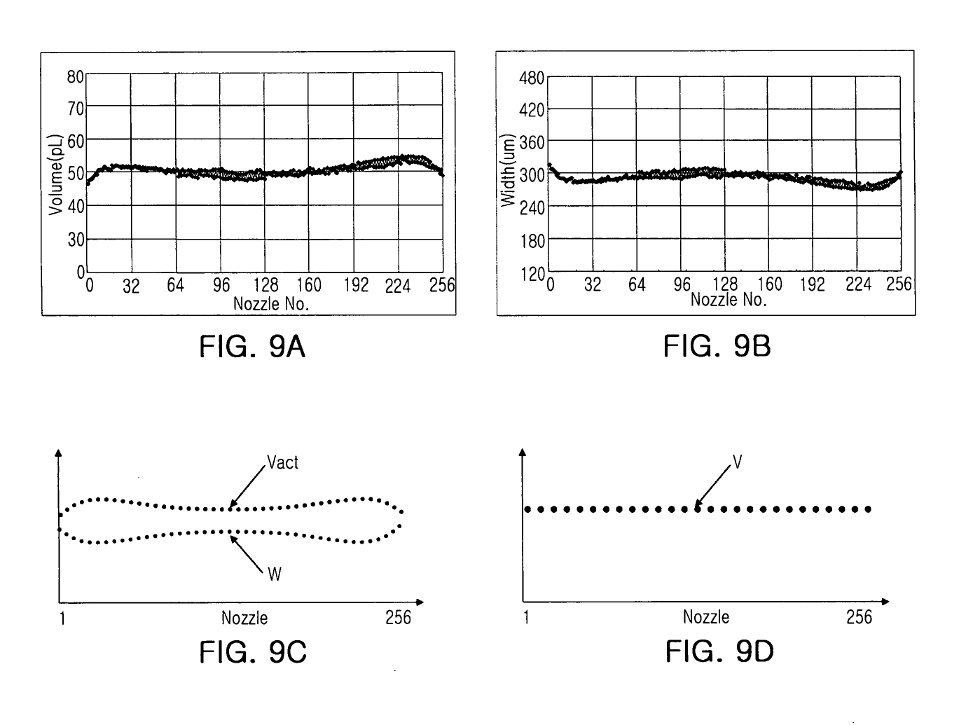

FIGS. 9A TO 9D is a graph illustrating the change of droplet ejection volume by an inkjet print head according to a fourth exemplary embodiment of the present invention.

The inkjet print head shown in FIGS. 9A TO 9D includes 256 head cells. When an ejection volume profile of droplets has a wave shown in FIG. 9A, the wave-type ejection volume profile is changed into an inverse wave type in the width of the upper electrode of the piezoelectric actuator to make the ejection volume of all the head cells uniform as shown in FIG. B. Since the rest components are the same as those of the inkjet print head according to the first exemplary embodiment of the present invention shown in FIG. 1, the components will not be described in detail and hereinafter, only differences therebetween will be primary described.

As shown in FIG. 9A, when the ejection volume profile of the droplet is shown, the profile of the width of the upper electrode is calculated as the inverse wave of the ejection volume profile in the piezoelectric actuator of all the head cells as shown in FIG. 9B. Herein, in a method of calculating the profile of the width of the upper electrode, for example, the ejection volume deviation in each head cell is acquired by Equation 2 and the profile which is in inverse proportion to the acquired volume deviation to acquire a profile of the width of the upper electrode to be adjusted.

As shown in FIG. 9C, when the width w of the upper electrode of the piezoelectric actuator of each head cell is adjusted on the basis of the acquired profile W of the width of the upper electrode, the uniform ejection volume profile V may be acquired in all the head cells as shown in FIG. 9D.

In the exemplary embodiment, an inverse wave of an ejection volume profile V_{act} has been applied to the width of the upper electrode of the piezoelectric actuator, but the present invention is not limited thereto and as shown in the second and third exemplary embodiments, the inverse wave may be applied to the width or length of the pressure chamber and an inverse wave of an ejection velocity profile may be applied.

In the exemplary embodiment, when the inverse wave of the ejection volume profile V_{act} is applied to the width of the upper electrode of the piezoelectric actuator of each head cell, the ejection volume profile is uniform in the entire head cell region as shown in FIG. 9D.

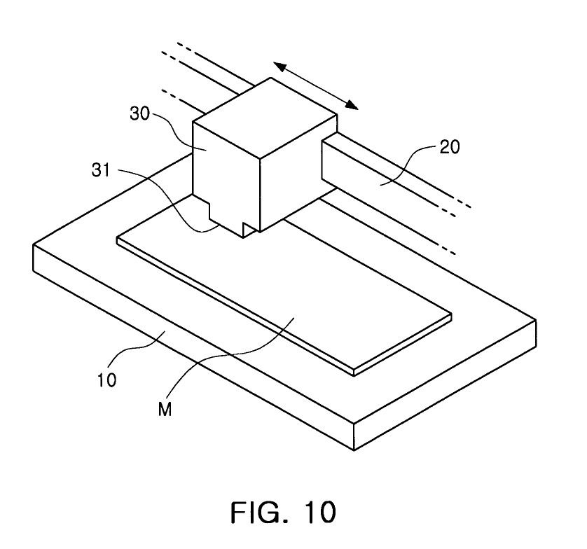

FIG. 10 is a diagram schematically illustrating the configuration of an inkjet printer including an inkjet print head according to the present invention.

The inkjet printer according to the present invention includes the inkjet print head described in the first, second, and third exemplary embodiments. Hereinafter, the detailed description of the configuration of the inkjet print head will be omitted for convenience of description.

Referring to FIG. 10, the inkjet printer according to the present invention may include a feeder (not shown) feeding a printing medium M, a support 10 supporting the printing medium M, an inkjet print head 30 ejecting ink on one surface of the printing medium M, and a carrier 20 guiding the inkjet print head 30 on the printing medium M.

The inkjet print head 30 moves to a location for ejecting ink on the printing medium M with the vertical movement of the carrier 20 and prints a predetermined pattern of a wire or an image on the printing medium M with the horizontal movement of the carrier 20. At this time, the printing medium M may be stably supported by the support 10 in printing.

As set forth above, according to exemplary embodiments of the present invention, an inkjet print head and an inkjet printer including the same can improve ink ejection characteristics by making droplet ejection velocity or volume of all head cells of the inkjet print head uniform.

While the present invention has been shown and described in connection with the exemplary embodiments, it will be apparent to those skilled in the art that modifications and variations can be made without departing from the spirit and scope of the invention as defined by the appended claims. For example, although the substrate with the ink passage has been described as the upper substrate and the lower substrate, it is exemplary and one substrate may be used or three or more substrates may be used and various types of substrates may also be used in respects to the type of the substrate. Accordingly, the scope of the present invention will be determined by the appended claims.

1. An inkjet print head, comprising:
an inkjet head plate with a plurality of head cells including ink passages where introduced ink is ejected through a nozzle by passing through a pressure chamber; and
a piezoelectric actuator formed on the top of the inkjet head plate and formed at a position corresponding to the pressure chamber,
wherein the area of at least one of the pressure chamber and the piezoelectric actuator is changed to make ejection characteristics of the ink ejected from the plurality of head cells uniform.

2. The inkjet print head of claim 1, wherein the plurality of head cells include head cells of a nonuniform region formed at an edge region of the inkjet head plate and head cells of a uniform region formed at the inside of the edge region, and
the area of at least one of the pressure chamber and the piezoelectric actuator of the head cells of the nonuniform region is altered more greatly than that of the head cell of the uniform region.

3. The inkjet print head of claim 1, wherein the plurality of head cells include head cells of the nonuniform region formed at the edge region of the inkjet head plate and head cells of the uniform region formed at the inside of the edge region, and
the area of at least one of the pressure chamber and the piezoelectric actuator of the head cells of the nonuniform region is altered more greatly stepwise from the center to the edge of the inkjet head plate.

4. The inkjet print head of claim 1, wherein the ink ejection characteristic is a velocity deviation Δνᵢ,
the plurality of head cells include head cells of the uniform region of which the velocity deviation is in the range of 0 to 5% and head cells of the nonuniform region of which the velocity deviation is larger than 5%, and
the area of at least one of the pressure chamber and the piezoelectric actuator of the head cells of the nonuniform region is changed in proportion to the velocity deviation,
wherein Δνᵢ=|νₐᵥₑ−νᵢ|/νₐᵥₑ×100 (νᵢ represents the ejection velocity of an i-th head cell and νₐᵥₑ represents the average ejection velocity of head cells of the entire region).

5. The inkjet print head of claim 1, wherein the ink ejection characteristic is a volume deviation ΔVᵢ,
the plurality of head cells include head cells of the uniform region of which the volume deviation is in the range of 0 to 5% and head cells of the nonuniform region of which the volume deviation is larger than 5%, and
the area of at least one of the pressure chamber and the piezoelectric actuator of the head cells of the nonuniform region is in proportion to the volume deviation,
wherein ΔVᵢ=|Vₐᵥₑ−Vᵢ|/Vₐᵥₑ×100 (Vᵢ represents the volume of ejected ink of an i-th head cell and Vₐᵥₑ represents the average volume of ejected ink of head cells of the entire region).

6. The inkjet print head of claim 2, wherein the area of at least one of the pressure chamber and the piezoelectric actuator of the head cells of the nonuniform region is changed to 20% or less smaller than the area of at least one of the pressure chamber and the piezoelectric actuator of the head cell of the uniform region.

7. An inkjet print head, comprising:
an upper substrate including an ink inlet;
a lower substrate with a passage where ink introduced into the ink inlet is ejected through a plurality of nozzles by passing through a plurality of pressure chambers; and
a plurality of piezoelectric actuators formed on the top of the lower substrate and formed at positions corresponding to the plurality of pressure chambers,
wherein the area of at least one of the pressure chamber and the piezoelectric actuator is changed to make ejection characteristics of the ink ejected from the plurality of nozzles uniform.

8. The inkjet print head of claim 7, wherein the inkjet print head includes a nonuniform region positioned at an edge region of the inkjet print head and a uniform region disposed at the inside of the edge region, and
the area of at least one of the pressure chamber and the piezoelectric actuator of the nonuniform region is altered more greatly than that of the uniform region.

9. The inkjet print head of claim 7, wherein the inkjet print head includes the nonuniform region positioned at the edge region of the inkjet print head and the uniform region disposed at the inside of the edge region, and
the area of at least one of the pressure chamber and the piezoelectric actuator of the nonuniform region is changed largely stepwise from the center of to the edge of the inkjet print head.

10. The inkjet print head of claim 7, wherein the ink ejection characteristic is a velocity deviation Δνᵢ,
the inkjet print head includes the uniform region of which the velocity deviation is in the range of 0 to 5% and the nonuniform region of which the velocity deviation is larger than 5%, and
the area of at least one of the pressure chamber and the piezoelectric actuator of the nonuniform region is changed in proportion to the velocity deviation,
wherein Δνᵢ=|νₐᵥₑ−νᵢ|/νₐᵥₑ×100 (νᵢ represents the ejection velocity of an i-th nozzle and νₐᵥₑ represents the average ejection velocity of nozzles of the entire region).

11. The inkjet print head of claim 7, wherein the ink ejection characteristic is a volume deviation ΔVᵢ,
the inkjet print head includes the uniform region of which the volume deviation is in the range of 0 to 5% and the nonuniform region of which the volume deviation is larger than 5%, and
the area of at least one of the pressure chamber and the piezoelectric actuator of the nonuniform region is in proportion to the volume deviation,
wherein ΔVᵢ=|Vₐᵥₑ−Vᵢ|/Vₐᵥₑ×100 (Vᵢ represents the volume of ink ejected from the i-th nozzle and Vₐᵥₑ represents the average volume of ink ejected from nozzles of the entire region).

12. The inkjet print head of claim 8, wherein the area of at least one of the pressure chamber and the piezoelectric actuator of the nonuniform region is to be changed to 20% or less smaller than the area of at least one of the pressure chamber and the piezoelectric actuator of the uniform region.

13. An inkjet printer, comprising:
an inkjet head ejecting ink onto one surface of a fed printing medium;
a support supporting the printing medium below the inkjet head; and
a carrier guiding the movement of the inkjet head on the printing medium,
wherein the inkjet head includes,
an inkjet head plate with a plurality of head cells including ink passages where introduced ink is ejected through a nozzle by passing through a pressure chamber; and
a piezoelectric actuator formed on the top of the inkjet head plate and formed at a position corresponding to the pressure chamber,
wherein the area of at least one of the pressure chamber and the piezoelectric actuator is changed to make ejection characteristics of the ink ejected from the plurality of head cells uniform.

14. The inkjet printer of claim 13, wherein the plurality of head cells include head cells of a nonuniform region formed at an edge region of the inkjet head plate and head cells of a uniform region formed at the inside of the edge region, and
the area of at least one of the pressure chamber and the piezoelectric actuator of the head cells of the nonuniform region is altered more greatly than that of the head cell of the uniform region.

15. The inkjet printer of claim 13, wherein the plurality of head cells include head cells of the nonuniform region formed at the edge region of the inkjet head plate and head cells of the uniform region formed at the inside of the edge region,
the area of at least one of the pressure chamber and the piezoelectric actuator of the head cells of the nonuniform region is altered more greatly stepwise from the center to the edge of the inkjet head plate.

16. The inkjet printer of claim 13, wherein the ink ejection characteristic is a velocity deviation Δνᵢ,
the plurality of head cells include head cells of the uniform region of which the velocity deviation is in the range of 0 to 5% and head cells of the nonuniform region of which the velocity deviation is larger than 5%, and
the area of at least one of the pressure chamber and the piezoelectric actuator of the head cells of the nonuniform region is changed in proportion to the velocity deviation,
wherein Δνᵢ=|νₐᵥₑ−νᵢ|/νₐᵥₑ×100 (νᵢ represents the ejection velocity of an i-th head cell and νₐᵥₑ represents the average ejection velocity of head cells of the entire region).

17. The inkjet printer of claim 13, wherein the ink ejection characteristic is a volume deviation ΔVᵢ,
the plurality of head cells include head cells of the uniform region of which the volume deviation is in the range of 0 to 5% and head cells of the nonuniform region of which the volume deviation is larger than 5%, and
the area of at least one of the pressure chamber and the piezoelectric actuator of the head cells of the nonuniform region is changed in proportion to the volume deviation,
wherein ΔVᵢ=|Vₐᵥₑ−Vᵢ|/Vₐᵥₑ×100 (Vᵢ represents the volume of ejected ink of an i-th head cell and Vₐᵥₑ represents the average volume of ejected ink of head cells of the entire region).

18. The inkjet printer of claims claim 14, wherein the area of at least one of the pressure chamber and the piezoelectric actuator of the head cells of the nonuniform region is 20% or less smaller than the area of at least one of the pressure chamber and the piezoelectric actuator of the head cell of the uniform region.
